(19) United States
(12) Patent Application Publication
(10) Pub. No.: US 2008/0314258 A1
(43) Pub. Date: Dec. 25, 2008

(54) Rice and Egg Cooker

(76) Inventor: Scott Martin, Carson City, NV (US)

Correspondence Address: DERGOSITS & NOAH LLP, FOUR EMBARCADERO CENTER, SUITE 1450, SAN FRANCISCO, CA, 94111, US

(21) Appl. No.: 11/658,621

(22) PCT Filed: Aug. 2, 2006
(86) PCT No.: PCT/US2006/030255

§ 371 Date: Jan. 26, 2007

(51) Int. Cl. A47J 27/00

(52) U.S. Cl. 99/329 R

(57) ABSTRACT

A combination rice and egg cooker includes a lower rice unit (105) for cooking rice and an upper egg unit (130) for cooking eggs. The rice unit (105) includes a heater and a temperature transducer and a controller (113). When the rice is fully cooked the controller (113) disconnects the electrical power from the heater. The egg unit (130) cooks the eggs by heating water that surrounds the eggs, heating steam that surrounds the eggs or through a combination of steam and simmering water.

### FIELD OF THE INVENTION

The present invention relates to an electric combination rice and egg cooker for general household use.

### BACKGROUND OF THE INVENTION

A well-known meal in many countries consists of steamed white rice and boiled eggs. In the past rice and eggs have been cooked individually in separate cooking devices. Rice is typically cooked in a pot on a stove or in a rice cooker. Similarly, the eggs are generally boiled in a pot on a stove or an egg cooker. When cooking in a pot, the cooking temperature and cooking duration must be carefully monitored to properly control the heat applied to the pot.

Rice cookers simplify the cooking process by automatically controlling the heat that is applied to the food for cooking. Rice cookers include a container that holds the uncooked rice and water, an electric heating element and a controller. An electric heating element heats the water to cook the rice. When the rice is fully cooked, the heat is automatically turned off by the controller and a signal indicates that the rice is ready to eat. Modern rice cookers include timers that can be programmed to so that rice that is placed in the cooker will be fully cooked at a later time programmed by the user.

Existing egg cookers operate in a similar manner. The eggs and water are placed in the egg cooker. A heating element heats the water and cooks the eggs. A controller automatically turns the heat off when the eggs are properly cooked. Although both rice cookers and eggs cookers exist as separate appliances, a single device which has the ability to simultaneously cook both rice and egg cooker would prepare meals with more efficiency and reduce the occupied kitchen counter space.

### SUMMARY OF THE INVENTION

The present invention is a single unit egg and rice cooker that has separate cooking compartments for the rice and the eggs. The inventive device also has controls for altering the cooking processes for the rice and eggs. The single unit is an improvement over separate egg and rice cookers because it requires less kitchen counter space than separate rice and egg cookers. The cooking controls are also simplified. A normal user will typically cook the rice and eggs in the same manner. Thus, the cooking controls are first adjusted to produce the desired rice and egg meal. After the rice and egg cooking controls has been properly set, the cooking process is easily repeated by placing the same quantity of rice, eggs and water in the cooker. In an embodiment, a single button is pressed to cook both the rice and the eggs. In alternative embodiments, the rice cooker and egg cooker have separate cooking controls.

The inventive apparatus is arranged in a stacked configuration that includes a lower rice unit, an upper egg unit and a lid. In order to cook the rice, the dry rice and water are placed in the rice unit and eggs are placed in the egg unit. The egg unit is stacked on top of the rice unit and functions as a lid. A separate lid is placed over the egg unit. An electrical cord is attached to the egg unit and plugged into an electrical power outlet. A controller controls the electrical power that is applied to heating elements that boil the water that cooks the rice and eggs. After the food is cooked, the top lid is removed to access the egg compartment and the egg compartment is removed to access the lower rice compartment. Although the inventive system is intended to cook rice and eggs simultaneously, it is also possible to use the system to cook only rice or only eggs.

While the present invention uses heating elements in the rice unit to boil the water and cook the rice, several alternative cooking methods can be used to cook the eggs. In one embodiment, the steam from the rice unit is also used to cook the eggs. The steam in the rice unit rises and flows through vents in the bottom of the egg unit and the steam heat cooks the eggs. The vents are adjustable so that the amount of steam used to cook the eggs can be controlled. The vents may be adjusted by the system's controller or manually. The vents may be adjusted so that the eggs are fully cook when the rice is finished cooking.

In other embodiments, the rice unit and the egg unit may each have separate heating elements that independently boil water that is placed in both the rice and egg units. The separate heating elements allow the egg unit and the rice unit to function independently. In yet another embodiment, the egg unit may have a heating element and steam vents that allow the eggs to be cooked with a combination of heating elements and steam from the rice unit.

The inventive system also includes a cooking controller. The rice unit includes a temperature transducer that monitors the temperature of the rice unit. While liquid water exists in the rice unit the temperature will not exceed the boiling point of water. Once the water evaporates or is absorbed into the rice, the heat is no longer used to convert water into steam and the temperature of the rice unit exceeds the boiling point of water. The temperature transducer detects this rise in temperature and the control system turns the power to the heating elements in the rice unit off or to a lower warm setting. The controller for the rice unit may be a simple mechanical system or a more complex microprocessor “fuzzy logic” controller.

Various control systems may be used with the egg cooker. If the eggs are cooked only with steam from the rice unit, a variable vent mechanism may be the only device used to control the egg cooker. Alternatively, the egg unit may have a temperature transducer and a timer. The system may calculate the proper cooking time based upon the varying steam temperature and adjust the vents accordingly. When the eggs are fully cooked, the system may close the vents to prevent the eggs from being over cooked. If the egg unit has dedicated heating elements, water is placed in the egg unit and a temperature transducer is used to monitor the cooking temperature. When the water has evaporated, the temperature will rise above the boiling point of water. The transducer will detect a rise in temperature and turn off power to the egg unit heating elements.

The inventive egg and rice cooker may also have a timer and cooking controls. The controls allow the user to set the time at which the food is cooked. By placing the uncooked rice and eggs into the separate compartments with water and setting the cooking controls, the food will be fully cooked at a predetermined time. An alarm or a visual display may indicate that the rice and eggs are fully cooked. Additional controls may be included which allow the user to alter the cooking of the food. For example, if the user prefers drier rice, the system can be set to cook the rice longer than normal. Similarly, the eggs may be cooked for a short period of time to produce soft boiled eggs and longer to produce hard boiled eggs.

### BRIEF DESCRIPTION OF THE DRAWINGS

FIG. 1 illustrates a cross sectional view of a first embodiment of the rice and egg cooker;

FIG. 2 illustrates a bottom view of vents in the egg cooker;

FIG. 3 illustrates a bottom view of vents in the egg cooker;

FIG. 4 illustrates a cross sectional view of a second embodiment of the rice and egg cooker;

FIG. 5 illustrates a cross sectional view of a variation of the second embodiment of the rice and egg cooker;

FIG. 6 illustrates a cross sectional view of a third embodiment of the rice and egg cooker; and

FIG. 7 illustrates a diagram of the controller and associated components of the rice and egg cooker.

### DETAILED DESCRIPTION

The following is a detailed description of the presently preferred embodiments of the present invention. However, the present invention is in no way intended to be limited to the embodiments discussed below or shown in the drawings. Rather, the description and the drawings are merely illustrative of the presently preferred embodiments of the invention. The invention is directed towards a combination rice and egg cooking system that has separate cooking chambers for the rice and eggs.

The preparation of rice and eggs includes a cooking process that requires accurate timing and proper heating. Errors can result in undercooked or overcooked rice and eggs. The invention automatically controls the heat and timing in the preparation of the rice and the eggs. By combining the rice and egg cooking, the inventive rice cooker significantly reduces and simplifies the cooking process. The invention is also more energy efficient because the heat that would normally be vented is used to cook the eggs and is also more space efficient because a single unit replaces multiple cooking appliances.

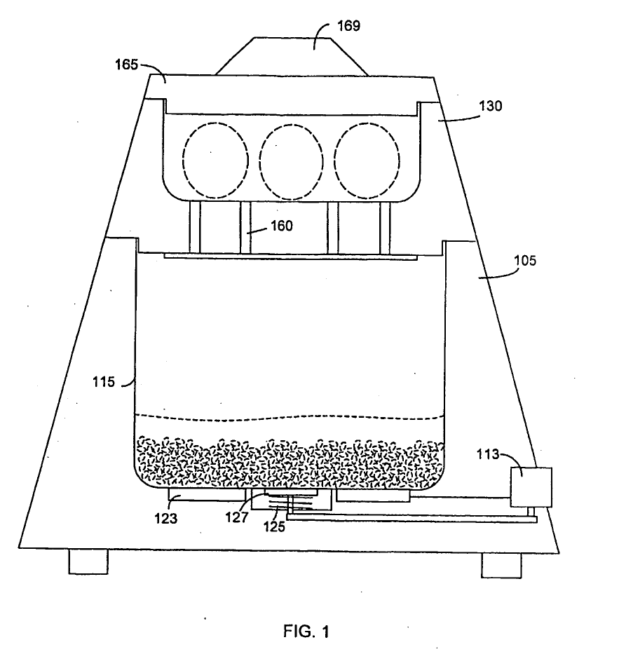

FIG. 1 illustrates a cross section of a first embodiment of the rice and egg cooker 100 that uses a mechanical controller. The rice unit 105 houses a rice pot 115 that holds the water and rice during the cooking process. The rice pot 115 is made of durable aluminum, but can also be made from plastic or a polyurethane material. The inner surfaces of the rice pot 115 may have a silicone or Teflon® coating to prevent the rice from browning or sticking and simplifies cleaning. Pot 115 also has inner volume markings to enable the user to accurately measure the amount of rice and water placed in the pot 115. Different volume scales may be used for white and brown rice since brown rice requires more water. The bottom edge of the rice pot 115 has a radius of about 1-3 inches which allows the rice at the bottom of the container to be easily scooped out with a traditional wooden or plastic rice paddle. The rice pot 115 in the rice unit 105 is usually removable so that it can be placed in a dishwasher or more easily washed by hand without exposing the rest of the rice and egg cooker 100 to soap and water. The volume of rice pot 115 may be approximately 2.5 liters. However, the volume may also be larger for commercial grade units or smaller for compact travel-sized units. The rice unit 105 is well insulated so that during the cooking process, the outer surface does not become hot enough to cause injury to anyone coming into contact with the rice cooker.

The rice unit 105 also has a heating element 123 and a mechanical controller 113. The controller 113 is electrically connected to an electrical power source (not shown) via a known connecting means such as a normal two pronged plug that fits into a wall socket. The electrical power source will typically be 110 volt alternating current (AC) however it is also possible to configure the heating element 123 to operate from a direct current (DC) power source. The controller 113 is coupled to a thermostat 127 and the heating element 123 and controls the electrical power that is applied to the heating element 123. A spring 125 and thermostat 127 are mounted under the rice pot 115. The spring 125 presses the thermostat against the bottom of the rice pot 115 so that it remains in contact with the base of the cooking bowl to accurately monitor the temperature of the rice pot 115. Holding member may be a permanent magnet that is attracted against a force of coil spring 125 to a magnetic member which loses its magnetic property at the magnetic transformation point. The magnetic member has a physical characteristic of rapidly decreased magnetic permeability at a predetermined temperature (for example 130° C.). Thus, the thermostat 127 is constructed such that the magnetic attractive force to the rice pot 115 disappears at the predetermined temperature and is configured to inform the controller 113 when the water in the rice chamber 115 is fully vaporized. The controller 113 then places the rice cooker into warming mode to keep the rice warm after it is fully cooked.

The controller 113 may be a simple mechanical device or a complex electronic device. All controllers 113 have an operator on/off control which allows the user to start and stop the cooking process. In the simple mechanical embodiment, there is a mechanical connection between the thermostat 127 and the controller 113. When the temperature rises above the boiling point of water indicating that all water is removed, the thermostate 127 trips the controller 113 to turn power to the heating elements off or to a warm setting. In a more complex fuzzy logic system, the thermostat 127 includes a temperature transducer that is coupled to the controller 113. The controller 113 varies the power to the heating elements in response to the detected rice pot 115 temperature and cooking time to cook the rice as desired by the user such as wet rice or dry rice. Again, if the temperature exceeds the boiling point, the controller 113 knows that all water has been vaporized and that the power to the heating elements 123 should be turned down.

While the rice unit 115 remains functionally the same for all embodiments of the present invention, it is contemplated that a few different egg unit 130 configurations can be used. In a first embodiment, the bottom of the egg unit 130 has one or more steam vents that allow hot steam generated by the rice unit to be used to cook the eggs in the egg chamber. In a second embodiment, the egg unit 130 has steam vents as well as a dedicated heating element. Water and eggs are placed in the egg unit 130 and the eggs are cooked with a combination of heat from the heating elements and steam from the rice unit. In a third embodiment, the rice unit 115 and egg unit 130 have separate heating elements that allow the rice unit and the egg unit to operate independently. The heating elements in the rice unit 115 are only used to cook the rice while the heating element in the egg unit 130 is only used to cook the eggs. In this third embodiment, there are no vents to allow steam from the rice unit 115 to flow into the egg unit 130.

FIG. 1 illustrates the first embodiment of the invention in which only steam is used to cook the eggs in the egg unit 130. The egg unit 130 is mounted above rice unit 113 and has an interior egg chamber 135 which holds the eggs during the cooking process. The lower surface of the egg unit 130 engages the opening of the rice unit 105 and functions as a lid. In an embodiment, the lower surface of the egg unit 130 is a circular depression that is slightly smaller in diameter than the opening at the top of the rice unit 113. Egg chamber 135 may be made of good heat conductive material, such as aluminum, and its interior surface may be polished to enhance heat reflection. Alternatively, the egg chamber 135 can be made from or have a coating that includes a polyurethane material with a silicone or Teflon® coating to allow easy cleanup in case of egg breakage and spills. Softer chamber materials or a soft layer of porous material placed under the eggs will reduce the chance of breaking the eggs as they are placed in the egg unit 130.

The egg chamber 135 may be large enough to cook about 3 to 7 large eggs. The volume of the egg cooker is be smaller than rice chamber 113 and may have a volume of about 0.5 liters. Like the lower chamber 113, the second body 130 is also insulated so that the outer surfaces do not become hot while the eggs are cooking. A lid which engages the opening at the top of the egg unit 130. The lid may have a circular structure that engages the inner diameter of the egg chamber 135. A gas seal mechanism (not shown) may be placed at the connection between the rice unit 105 and the egg unit 130 so that all steam will pass through the vents 160 rather than out of the connection between the rice unit 105 and the egg unit 130.

It is also possible to cook the eggs with a combination of boiled water and steam or with steam from the rice unit 105. In an embodiment, the egg unit 130 has one or more vents 160 that allow steam from the lower rice unit 105 to enter the egg unit and cook the eggs. This feature improves the efficiency of the system by using heat that would otherwise be vented from the rice unit 105. The vents 160 are adjustable so that the incoming volume of steam can be controlled. The vent 160 may be controlled manually or through the controller 113 which is coupled to a temperature transducer that monitors the temperature and adjusts the vents 160 to maintain the proper cooking conditions. By adjusting the vent opening, the heat provided to the egg unit may be set so that the eggs and rice will be fully cooked at the same time. Because the egg unit 130 does not include a heater there may not be any electrical power connections between the rice and the egg units. In an embodiment, the egg unit 130 may have a temperature transducer (not shown) that transmits temperature signals to the controller 113. The temperature signals may be transmitted through a direct electrical connection.

Alternatively, the temperature transducer may be coupled to a radio frequency transmitter and the temperature signals may be transmitted wirelessly to a receiver that is coupled to the controller 113. The controller 113 may indicate when the eggs are done based upon the temperature and duration of heat or the controller may adjust the vents 160 to control the temperature of the egg chamber 135.

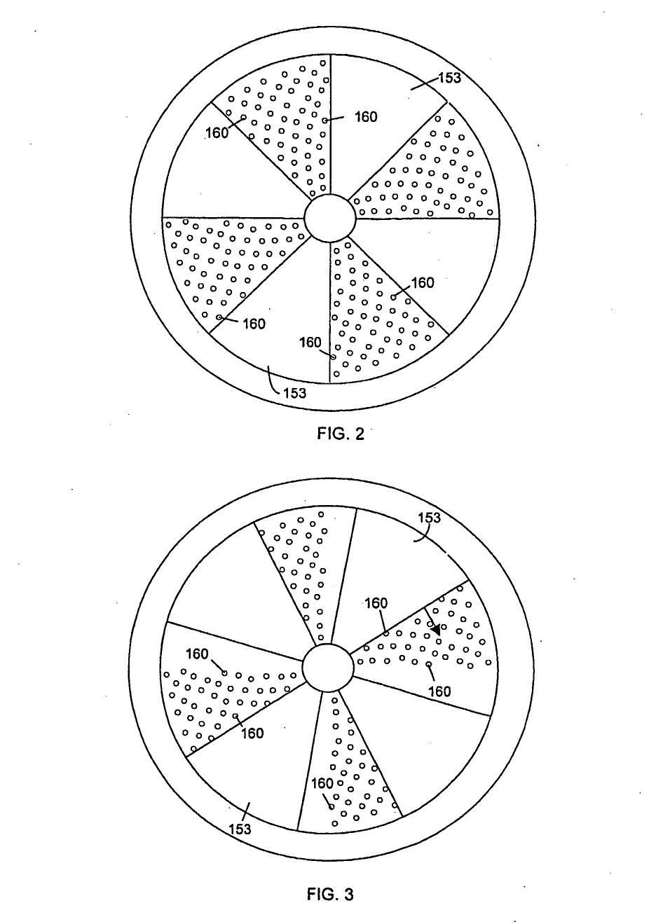

The flow of steam through the vents 160 allows the eggs to be cooked with steam rather than being immersed in boiling water. With reference to FIGS. 2 and 3, the bottom of the egg unit 130 with a louver 153 mechanism is shown. In an embodiment, the flow of stem through the vents 160 is controlled with a rotatable louver 153 mechanism. The vents 160 may be machined or molded holes that are formed directly into the bottom of the egg unit 130. The steam vents 160 may be about 1/16th of an inch in diameter, but may also be bigger for larger industrial size rice cookers. The louver 153 is a flat circular member that has plates that cover some of the vents 160. In FIG. 2, the louver 153 is rotated to open all of the vents 160. With reference to FIG. 3, when the louver 153 is rotated, some of the vents 160 are covered so that steam will not pass through some of the vents 160 to the egg chamber. By closing some of the vents less heat from the rice unit 105 flows into the egg unit 130. If eggs are not being cooked, the louver 153 may be rotated so that all of the vents 160 are closed and the steam remains in the rice chamber 115.

In an embodiment the louver 153 may be a manual twist covering which opens and closes the vents 160 to control the flow of steam into the egg chamber 135. In this embodiment, the louver 153 is set to provide the proper amount of steam heat to cook the eggs with the steam provided by the rice unit. Experimental data may be used to determine the proper setting of the louver 153 depending upon the quantity of rice and eggs being cooked. In another embodiment, the position of the louver 153 may be controlled by a solenoid or any other similarly electric motor. The controller 113 may monitor the temperature of the egg chamber 135 and control the position of the louver 153 to maintain the proper cooking heat. When the eggs are properly cooked, the controller 113 may close the vents 160 to stop the cooking of the eggs and keep the eggs warm. In other embodiments, various other mechanisms may be used to control the flow of steam from the rice unit 105 to the egg unit 130 including solenoid valves, non-louvered vents, orifices, ducts, screens, etc. Any one or any combination of these devices may be placed between the rice chamber 115 and the egg chamber 135.

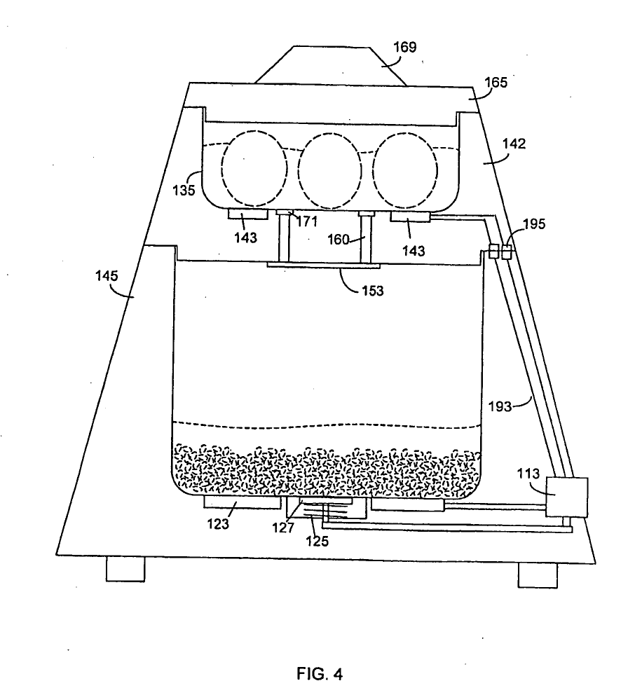

With reference to FIG. 4, in the second embodiment the eggs are cooked with a combination of water boiled by dedicated heating elements 143 in the egg unit 142 and steam from the rice unit 145. In this second embodiment, water and eggs are placed in the egg chamber 135 and the water is heated by the steam generated from the rice unit 145 as well as the heating elements 143. The controller may apply a specific voltage to the heating elements 143 for a specific period of time. Alternatively, the egg unit 142 may include a temperature transducer (not shown) that sends temperature information to the controller 113 so that the egg temperature can be properly maintained until the eggs are properly cooked. In this embodiment, valves 171 are placed at the tops of the vent 160 which allow steam to enter the egg unit but prevent water from flowing from the egg unit 142 to the rice unit 145.

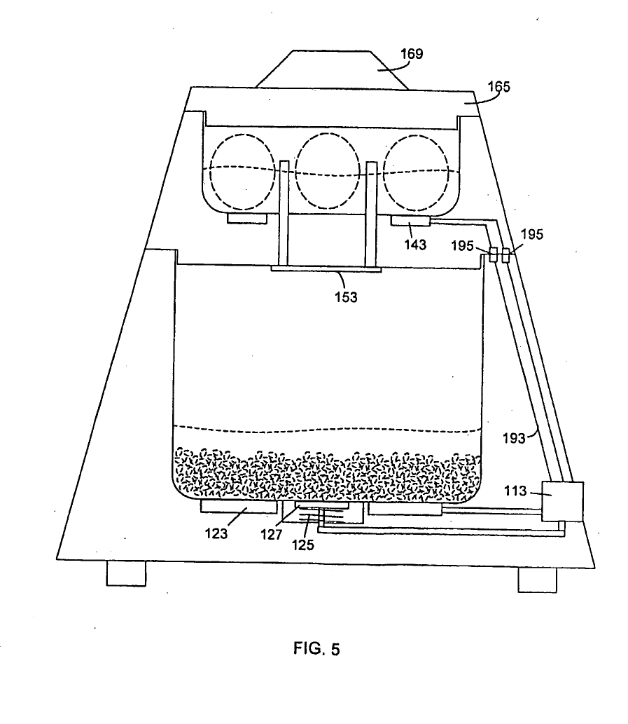

With reference to FIG. 5, as an alternative to valves that prevent water from flowing down from the egg unit 142 into the rice unit 145, the tubular vents 160 may extend above the water line in the egg unit 142. The vents 160 can be made of durable aluminum, but can also be made from, rubber, plastic, or a similar substance with a silicone or Teflon® coating to allow for easy cleanup and is dishwasher safe. Chamber 135 may also have markings 137 to enable the user to accurately measure the amount of water required to properly cook the eggs. This embodiment is more energy efficient because excess heat from the rice unit is used to cook the eggs.

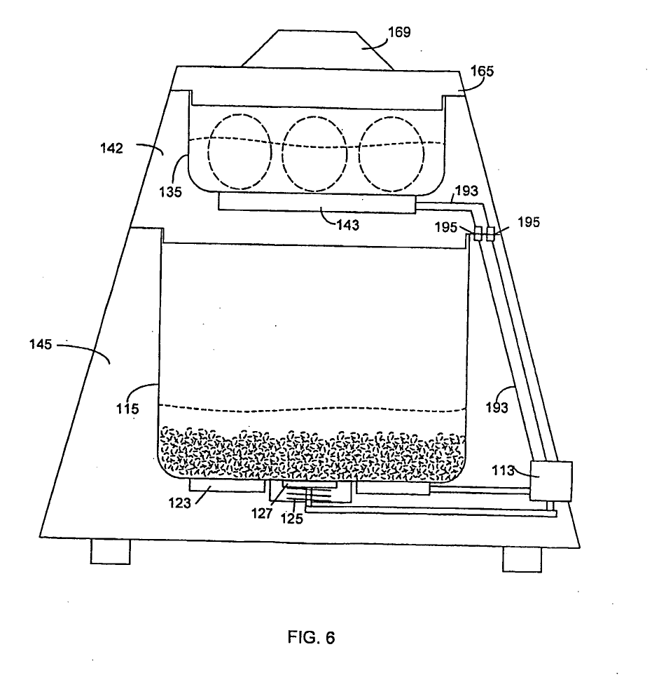

With reference to FIG. 6, a third embodiment is illustrated in which the egg unit 149 and the rice unit 145 each have separate heating elements and no vents. In this embodiment, the egg unit 149 and the rice unit 145 cook their respective items independently. Water is placed in both the egg unit 149 and the rice unit 145 and one unit can be operated while the other is turned off. The heating element 123 in the rice unit 145 boils the water used to cook the rice and the heating element 157 in the egg unit 182 is used to cook the egg. Because there are no vents, the steam is not passed into the egg unit.

In the second and third embodiments of the invention as shown in FIGS. 4, 5 and 6, the heating elements 143 may be coupled to the controller 113 by electrical conductors 193. Connectors 195 may be used to connect the electrical conductors 193 at the junction between the egg unit 132 and the rice unit 105. The connectors 193 disconnect the conductors 193 when the egg unit 132 and the rice unit 105 are separated.

Because the powered connectors 195 may be exposed, the heaters 157 are preferably low voltage units such as 12 volts or lower in order to minimize the risk of accidental electrocution. In an embodiment, the system may have a sensor that detects the presence of the egg unit 142 on the rice unit 145 and shut off power to the conductors 193 if the egg unit 142 is not in place. The connectors 195 may be various devices including: exposed conductors, recessed pins and plugs, etc. In an embodiment, the connectors 195 may include concentric rings so that the egg unit can be placed on the rice unit in any orientation and be properly coupled to the connectors 195.

The heating elements 123, 157 used to heat the rice chamber 115 and the egg chamber 135 both convert electrical energy into heat. The electrical power used by the heating element 123 is typically 110 volts alternating current (AC) although the heating elements may operate in a low voltage DC or AC. An electrical cable is connected to a controller 113 in the lower rice unit 145 which controls the power applied to the rice heater 123 and the egg heater 157. The heaters 157 in the egg unit 142 draw energy from the controller in the lower unit. When the egg unit 142 is placed on the rice unit 145 an electrical connection is formed. Because the electrical connectors 193 may be exposed, the heating element 157 in the egg unit 132 is a low voltage mechanism of about 12 V DC or AC in the preferred embodiment.

In yet another embodiment, the connection between the controller 113 and the heaters 157 may be through an inductive connection rather than direct electrical contact.

The controller may produce an electromagnetic field to coils wrapped around the upper diameter of the rice unit 145. These coils may be placed in close proximity to corresponding coils that are mounted in the lower diameter of the egg unit. The coils in the egg unit 142 are coupled to the heater elements 157. Electrical power from the controller 113 is used to produce a magnetic field and the coils in the egg unit 142 convert the magnetic energy into electrical energy used to power the heating elements 157. When the magnetic field is turned off, the power to the heating elements 157 is also stopped. This type of electrical connection may be safer than having exposed electrical connectors because there is no chance of improperly connecting the egg unit 142 to the rice unit 145 or creating an electrical short through the exposed powered connectors 195.

A top lid 165 covering the top of the egg unit 142 may be a separate piece or may have a hinged connection to the egg unit 142. The lid 165 may be made from a metal, plastic or any other heat resistant material. A grip handle 169 is integrally formed on top of lid 165. In an embodiment, the lid 165 may also have a lock member which can hold the top lid 165 in a closed position and prevent excess steam from escaping. With the lock member engaged, the lid 165 can be released by pushing a lid release button. The bottom of the lid 173 is constructed to contact along its outer periphery with the outer periphery of the top of the opening of rice unit 145.

In another embodiment, the egg unit includes an egg tray. A problem with cooking eggs is that they can easily break. When the eggs are placed in a pot of boiling water, the movement within the water can cause the eggs to collide with a wall of the pot or each other and crack. The egg cooking container may have a flexible layer that reduces the risk of breaking the eggs. To prevent this type of breakage, the eggs may be placed in a removable egg tray that fits in the egg chamber. The advantage of having an egg tray is that it keeps the eggs from touching each other and potentially cracking during the cooking process. The egg tray has spherical indentations in the shape of the base of an egg to better hold and stabilize the eggs while cooking. Indentations are uniformly dispersed in a circular pattern on egg tray.

Yet another feature of the inventive rice and egg cooker is the external shape. The inventive rice and egg cooker has a conical exterior surface that is shaped in proportion to the “Golden Ratio” which is the ratio of “a” to “b” in the formula (a+b)/a=a/b=the irrational number of 1.618033989 . . . . In the preferred embodiment, a=height and b=base so that the height of the cooker is about 1.618 times the base. From a mathematical point of view, the golden ratio is notable for having the simplest continued fraction expansion. The golden ratio is also related to the “golden angle” which is created by dividing the circumference of a circle into a section a and a smaller section b such that c=a+b and c/a=a/b. This results in a right triangle that has the angle of 137.51°. In the preferred embodiment, the outer sides of the rice and egg cooker have a conical shape that is defined by the golden angle. While the preferred embodiment includes the described geometric designs, it is contemplated that any other housing geometry can be used for the exterior surfaces of the inventive rice and egg cooker.

To cook white rice, the proper volume of rice and cold water are measured and placed in the rice pot 115. The user can also use the appropriate graduation markings in the rice pot 115. The user then actuates the controller 113 which goes through a specific control sequence to properly cook rice. The rice and water are initially heated by the heating element 123. The heating element 123 induces eddy current at first inner pot 115, which slowly heats inner pot 115, so as to promote a so-called soaking process during which water is absorbed in each grain of rice. After the soaking process is performed for a predetermined period, inner pot 115 is heated at a high temperature, so that the temperature of the water in which the rice is immersed is rapidly elevated to the boiling point.

Ideally, the white rice is cooked at the boiling temperature of water for about 20 minutes. At the end of the cooking process, all of the water should either evaporate and be absorbed by the rice. It is well known that the temperature of water will not exceed the boiling temperature of 100° C. at sea level atmospheric pressure. Water will boil at lower temperatures at higher elevations. Thus, the temperature of the rice pot 115 will not exceed the boiling temperature until all the water has been absorbed by the rice or has evaporated. After the water is removed, the temperature of the rice container quickly rises. When the temperature exceeds the boiling temperature of 130° C., there is no more water in the rice pot 115 and the rice is fully cooked. The thermostat is set to a temperature above the boiling point. When the thermostat indicates that the temperature is above 100° C., the controller 113 switches the rice cooker into “warm” mode, which keeps the rice warm until it is served and an audio and/or visual indicator may be actuated indicating that the rice is done. The warming mode temperature is typically about 75° C. In other embodiments, the controller may simply turn the heating element 123 off.

The thermostat and the controller may be various devices ranging from simple mechanical to microprocessors. For example, the thermostat may be a simple bimetallic device that physically moves an electrical switch when a set temperature has been exceeded. The controller may also be a simple mechanical device that is actuated by a spring loaded mechanical switch. When the the user presses the control switch, the controller directs electrical power to the heating unit and a light that indicates that the unit is working. After the thermostat senses that the rice is fully cooked, i.e. the rice bowl temperature rises above 100° C. the controller to turn the power to the heating element off and-turn off the light indicating that the rice and eggs are fully cooked.

In addition to the aforementioned mentioned mechanical control apparatus for operating the rice and egg cooker, it is envisioned that the invention could also be used with a wide variety of operating systems, including modern control systems employing fuzzy logic technology to cook rice and eggs.

In these other embodiments, the rice and egg cooker may use more complex electronic devices. The system may utilize thermal sensors and a digital controller. The thermal sensors may be a temperature probes or transducers that are in physical contact with the rice pot and the egg chamber. The thermal sensors may produce signals that correspond to the rice pot and egg chamber temperatures. The controller may monitor the thermal sensor and continuously adjust the power supplied to the heating unit to keep the rice and eggs at the optimal cooking temperature until the rice is fully cooked.

The microprocessor controlled rice and egg cooker can be configured to monitor many different variables and control the cooking of the rice and eggs accordingly. A rice and egg cooker control unit may obtain a value or a combination of values indicative of an amount of rice and eggs to be cooked, and the controller can sue these values to determine a level of heating power to be supplied to the rice heating element and the egg cooking element. In contrast to a simple mechanical device, the microprocessor controlled cooker can be configured to determine a plurality of cooking control parameters, based on a specified degree of final hardness of the cooked food, which can be selectively inputted by the user. These additional controls and cooking parameter monitors may be part of a neural network that is controlled by the microprocessor. These advanced cooking controlled rice cookers are more commonly known as “fuzzy logic” rice cookers. In an embodiment, the controller may control the power to the rice unit heating elements so that the temperature is close to 100° C. for a specific duration of time which is dependent upon the type of rice. In this embodiment, the user would specify the type of rice and the controller would maintain the proper cooking temperature for the duration of time specified in Table 1 below.

TABLE 1

| Type of Rice | White Rice | Brown Rice | Parboiled/Converted Rice |
|---|---|---|---|
| Cook Time | 20 min. | 50 min. | 25 min. |

In other embodiments, the rice unit may also include a pressure transducer and a pressure seal at the opening of the rice pot. When the boiling process is initiated and the water begins to boil, steam is generated to make the pressure in inner pot higher than that in the atmosphere. Due to the increase of the pressure in inner pot, the temperature in inner pot elevates beyond the boiling point of 100° Celsius at the normal atmospheric pressure, so that the rice is cooked faster than at normal atmospheric pressure. The microprocessor controller can calculate the proper cooking time based upon the temperature and pressure compensating for the faster cooking at elevated pressure.

When the boiling process during a predetermined period is completed, a steaming process is initiated in the state where the heating is stopped. In the steaming process, the rice is steamed by the steam remaining in the cooking vessel after the boiling process, usually after the water in the rice pot is completely boiled away. After steaming for a predetermined amount of time, the steaming process is completed and any remaining steam in rice pot is exhausted, so that the pressure in rice pot is lowered. In this state, a warming process is initiated in which rice pot is maintained at a constant warm temperature by the controller monitoring the rice pot temperature and adjusting the rice heater accordingly.

In some of the embodiments described above, the steam emitted during the cooking of the rice is exhausted through opened steam vents that interconnect the rice unit to the egg chamber. The cooking time for the eggs in 100° C., one atmosphere pressure steam will primarily depend upon the type of preparation and the desired preparation. These cooking times are listed in Table 2 below. In an embodiment, the user will input the number, size and preparation of the eggs through an input mechanism. The controller may adjust the cooking time based upon the user cooking inputs and shut the vents and produce an audio and/or visual signal indicating that the proper cooking time has elapsed. Other factors that may influence the cooking time upon the number of eggs and pressure if the lid is sealed to the top of the egg unit. In other embodiments, the controller may control the steam inlet vents to control the temperature within the egg unit. When the eggs are exposed to the steam for the desired period of time, the eggs are cooked and the controller closes the inlet vent to stop the cooking. Because the required cooking times for the eggs are shorter than the cooking time for rice, the rice unit is able to provide a sufficient quantity of steam to properly cook the eggs. In an embodiment, the egg unit may also include an outlet vent that is closed to retain steam in the egg unit and open to allow the steam to escape to atmosphere. The venting of the steam will also help to stop the cooking of the eggs.

TABLE 2

| Egg Preparation | Small Egg | Medium Egg | Large Egg |
|---|---|---|---|
| Soft Boiled | 12 min. 40 sec. | 13 min. | 13 min. 20 sec. |
| soft whites/soft yolks | | | |
| Medium Boiled | 13 min. 20 sec. | 13 min. 50 sec. | 14 min. 15 sec. |
| hard whites/soft yolks | | | |
| Hard Boiled | 17 min. | 18 min. | 20 min. |
| hard whites/hard yolks | | | |

In other embodiments, the vents may be manually set before the cooking process. Markings on the bottom of the egg chamber and the louver can be used to assist the user in determining the proper louver setting that will cook the eggs as desired in the time that the rice is fully cooked. For example, the louver may have markings from 1 to 10 which correspond to the rotational position of the louver between closed and fully open. In the closed position all of the vents are covered and in the fully open position all of the vents are open. Experimentation may be performed to determine the proper settings for cooking the eggs that can be put in a table that is supplied with the rice and egg cooker. For example, to cook small softboiled eggs with white rice, the vents may be set to 3 and to cook large hardboiled eggs, the vents may be set to 9. In this embodiment, the eggs will be cooked when the rice is cooked. A

As discussed above with respect to FIGS. 5 and 6, the eggs may be cooked with egg unit heater alone or with the heater in combination with steam from the rice unit. Because the water is not absorbed by the eggs, it can only escape the egg container by being converted into steam and exiting the container. A sufficient amount of water should be placed in the egg container so that most of the eggs are immersed in water. Table 3 lists a variety of cook times and results for eggs partially submerged in simmering water. Because there is a much greater heat transfer between water and eggs than steam and the cooking times are much faster. In this embodiment, the power to the egg heater is applied so that that the eggs are cooked for the required time. After the proper cooking time has elapsed, the controller reduces the power to the egg heater is turned off. The controller may also turn off the vent to prevent steam from entering the egg unit and open the vent to release steam from the egg unit.

TABLE 3

| Egg Preparation | Small Egg | Medium Egg | Large Egg |
|---|---|---|---|
| Soft Boiled | 2 min. 40 sec. | 3 min. | 3 min. 20 sec. |
| soft whites/soft yolks | | | |
| Medium Boiled | 3 min. 20 sec. | 3 min. 50 sec. | 4 min. 15 sec. |
| hard whites/soft yolks | | | |
| Hard Boiled | 7 min. | 8 min. | 10 min. |
| hard whites/hard yolks | | | |

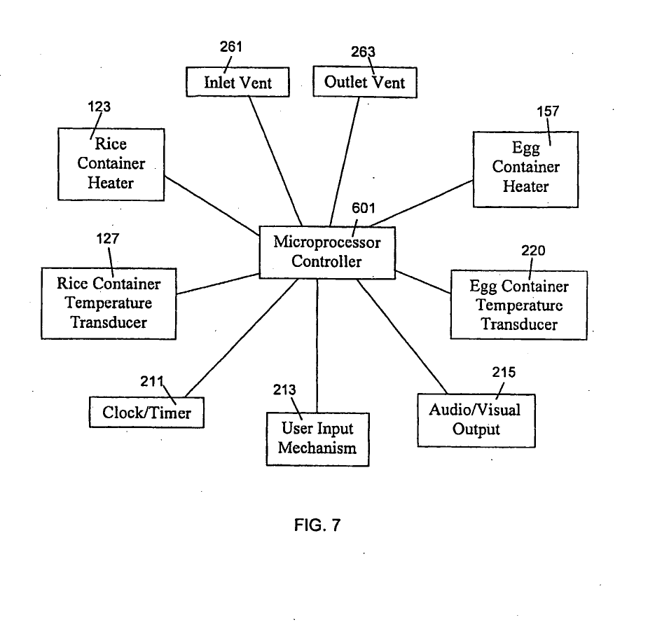

With reference to FIG. 7, a diagram illustrating the connections between a microprocessor controller 601 and the other components of the rice and egg cooker. For example, the controller 601 allows the cooking of the eggs and rice to be precisely controlled by controlling the power applied to the rice heating unit 123 and the egg heating unit. The rice heating unit 123 heats the water to a simmer and then cooks the rice for a specific amount of time that is set by the user. The controller 601 may use the rice container temperature transducer 127 to detect that the temperature of the rice container. If the container is cool, high power is applied to the heating unit 123. After the temperature has reached the boiling point of water, the power is reduced. Controller 205 also adjust the cooking time based on the quantity and the texture of cooked rice desired that is input by the user through the user input 213. The user input mechanism 213 may include a control button and other cooking control inputs such as a numeric keypad and dedicated buttons or other inputs for the different types of rice, preparation of rice such as wet, normal or dry, etc. The cooking settings for the may be displayed on a visual output 215 which may include a graphical display or an illuminated display that indicates the operation of the rice and egg cooker.

If the cooker includes an egg unit heating element, the controller 601 applies power to the egg heats 157 to bring the water to a simmer and then cooks the eggs for a time that corresponds to the desired egg preparation that is set by the user through the user input mechanism 213. In an embodiment, controller 601 may set the cooking time based upon the size, number and desired type of cooked egg as listed in Table 3. The controller 601 may receive timing information from the clock/timer 211 unit. Controller 601 has a timing mechanism that turns the power to the heater on to bring the water in egg chamber 135 to a simmer, maintains the simmer temperature and then turns the heat off after the set cooking time has elapsed. Alternatively, controller 601 may have a cooking timer set that is set by the user. After the predetermined time has elapsed, the power to the egg container heater 157 is turned off. If the system uses steam from the rice unit to cook the eggs, the inlet vent 261 is initially open and the outlet vent 263 is closed by the controller 601. After the eggs are cooked, the inlet vent 261 is closed and the outlet vent 263 may be open by the controller 601.

The rice and egg cooker may also include a clock 211 that allows the cooking to be performed at a specific time. In this embodiment, the user places the rice, eggs and water into the cooker and programs the cook time through the user input 213. Controller 205 may have a clock that that allows the user to initiate the timing mechanism above at a predetermined time. Controller 205 may cause an optical or audio signal to be emitted by the audio/visual output 215 once the eggs and rice are finished cooking.

In an embodiment, the egg unit includes a temperature transducer 220 that monitors the cooking temperature of the eggs. As a safety mechanism, if the controller 601 receives signals from the egg container temperature transducer indicating that the temperature is above 130° C., the controller 601 may reduce or shut off the electrical power to the egg chamber heater 157. The detection of this temperature indicates that water does not exist in the egg unit and the reduction of power will prevent any potential over heating or burning of the egg unit.

Because the microprocessor is a low voltage DC digital device and the AC power and heater units are higher voltage analog devices, various electrical conversion components are required. Analog to digital converters transformers, inverters and rectifiers may be used to convert the residential AC power to a low voltage DC power. The controller may also be coupled to relays or servo controllers to control the higher voltage AC or DC electrical power that is applied to the rice heating unit 123 and the egg heating unit 157. If the outputs of the temperature transducers are analog, an analog to digital converter can be used to convert the signals to a digital format.

The heating elements used in the rice and egg cooker convert electricity into heat through the process of Joule heating. Electrical current running through the element encounters resistance, resulting in heating of the element. Most heating elements pass the electrical current through a nichrome wire or ribbon which has relatively high electrical resistance and does not break down or oxidize in air. In an embodiment the heating elements may be a sealed element which is a fine coil of nichrome wire in a ceramic binder, sealed inside a metal shell that fits within the housings.

While the present invention has been described in terms of a preferred embodiment above, those skilled in the art will readily appreciate that numerous modifications, substitutions and additions may be made to the disclosed embodiment without departing from the spirit and scope of the present invention. It is intended that all such modifications, substitutions and additions fall within the scope of the present invention that is best defined by the claims below.

What is claimed is:

1. A rice and egg cooker comprising:
a rice unit having an inner pot for holding rice and water, a first heating element for heating the inner pot, and a temperature transducer for monitoring the temperature of the inner pot;
an egg unit having an inner egg container for holding a plurality of eggs and water, a second heating element for heating the egg container and a lower surface that is removably mounted on the rice unit;
an electrical connector mounted between the rice unit and the egg unit that couple a first conductor in the rice unit to a second conductor in the egg unit when the egg unit is mounted on the rice unit; and
a controller that controls electrical power applied to the first heating element and the second heating element, wherein the controller reduces the power applied to the first heating element when the temperature transducer detects that the temperature of the inner pot has exceeded a predetermined set point and the controller reduces the power applied to the second heating element when a predetermined period of time has been exceeded.

2. The rice and egg cooker of claim 1, further comprising;
a temperature transducer for monitoring the temperature of the egg container that is coupled to the controller;
wherein the controller reduces the power applied to the second heating element when the temperature of the egg container has exceeded a predetermined set point.

3. The rice and egg cooker of claim 1, further comprising:
an input mechanism for inputting a desired egg preparation including: soft boiled, medium boiled and hard boiled;
wherein the predetermined period of time is determined by the desired egg preparation.

4. The rice and egg cooker of claim 1, further comprising
a clock;
a start cooking input mechanism for inputting a cooking start time; and
a visual display that indicates the cooking start time;
wherein the controller applies power to the first heating element at the cooking start time.

5. The rice and egg cooker claim 1, wherein the electrical connector that electrically couples the control unit to the second heating element in the egg unit is an inductive coupling mechanism.

6. The rice and egg cooker of claim 1, wherein the electrical connector includes a first conductor attached to the rice unit and a second conductor attached to the egg unit and the first conductor contacts the second conductor at a contact point between the rice unit and the egg unit.

7. The rice and egg cooker of claim 7, further comprising:
an audio or visual output device that indicates when the rice is cooked or when the eggs are cooked.

8. A rice and egg cooker comprising:
a rice unit having an inner pot for holding rice and water, a first heating element for heating the inner pot, and a temperature transducer for monitoring the temperature of the inner pot;
an egg unit having an inner egg container for holding a plurality of eggs, a lower surface that is removably mounted on the rice unit, a steam vent that allows steam from the rice unit to flow into the egg container and a vent flow control mechanism; and
a controller that controls electrical power applied to the first heating element;
wherein the controller reduces the power applied to the first heating element when the temperature transducer detects that the temperature of the inner pot has exceeded a predetermined set point.

9. The rice and egg cooker of claim 8, wherein the vent flow control mechanism is manually adjusted before the rice is cooked.

10. The rice and egg cooker of claim 8, further comprising:
a temperature transducer coupled to the egg container that is coupled to the controller;
wherein the control unit opens the vent flow control mechanism and closes the vent flow control mechanism after the eggs have been exposed to steam for a predetermined period of time.

11. The rice and egg cooker of claim 10, wherein the control unit closes the adjustable steam vent when the eggs have been cooked to a desired level.

12. The rice and egg cooker of claim 10, wherein the electrical connector includes a first conductor attached to the rice unit and a second conductor attached to the egg unit and the first conductor contacts the second conductor at a contact point between the rice unit and the egg unit.

13. The rice and egg cooker of claim 10, further comprising;
an input mechanism for inputting a desired egg preparation including: soft boiled, medium boiled and hard boiled;
wherein the predetermined period of time is determined by the desired egg preparation.

14. The rice and egg cooker of claim 8, further comprising
a clock;
a start cooking input mechanism for inputting a cooking start time; and
a visual display that indicates the cooking start time;
wherein the controller applies power to the first heating element at the cooking start time.

15. The rice and egg cooker of claim 8, further comprising:
an audio or visual output device that indicates when the rice is cooked or when the eggs are cooked.

16. A rice and egg cooker comprising:
a rice unit having an inner pot for holding rice and water, a first heating element for heating the inner pot, and a temperature transducer for monitoring the temperature of the inner pot;
an egg unit having an inner egg container for holding a plurality of eggs and water, a second heating element for heating the egg container, a lower surface that is removably mounted on the rice unit, and a steam vent that allows steam from the rice unit to flow into the egg container and a vent flow control mechanism;
an electrical connector mounted between the rice unit and the egg unit that couple a first conductor in the rice unit to a second conductor in the egg unit when the egg unit is mounted on the rice unit; and
a controller that controls electrical power applied to the first heating element and the second heating element, wherein the controller reduces the power applied to the first heating element when the temperature transducer detects that the temperature of the inner pot has exceeded a predetermined set point and the controller reduces the power applied to the second heating element and closes the vent flow control mechanism when a predetermined period of time has been exceeded.

17. The rice and egg cooker of claim 16, further comprising;
a temperature transducer to monitor the cooking temperature of the egg container.

18. The rice and egg cooker of claim 16, wherein the electrical connector that electrically couples the control unit to the second heating element in the egg unit is an inductive coupling mechanism.

19. The rice and egg cooker of claim 16, wherein the electrical connector includes a first conductor attached to the rice unit and a second conductor attached to the egg unit and the first conductor contacts the second conductor at a contact point between the rice unit and the egg unit.

20. The rice and egg cooker of claim 16, further comprising:
an input mechanism for inputting a desired egg preparation including: soft boiled, medium boiled and hard boiled;
wherein the predetermined period of time is determined by the desired egg preparation.
